(19) United States
(12) Patent Application Publication
(10) Pub. No.: US 2026/0004224 A1
(43) Pub. Date: Jan. 1, 2026

(54) Digital Dual-Cycle Task Management System For Enterprise Operations

(71) Applicant: SHING-JUNG KUO, Shanghai (CN)

(72) Inventor: SHING-JUNG KUO, Shanghai (CN)

(21) Appl. No.: 19/111,476

(22) PCT Filed: Jul. 15, 2024
(86) PCT No.: PCT/CN2024/105389

§ 371 Date: Mar. 13, 2025

(30) Foreign Application Priority Data
Jun. 28, 2024 (CN) 202410860493X

(51) Int. Cl. G06Q 10/067; G06Q 10/04; G06Q 10/0637

(52) U.S. Cl. CPC G06Q 10/067; G06Q 10/04; G06Q 10/0637

(57) ABSTRACT

The digital dual-cycle task management system for enterprise operations, comprising a process sorting module, a digital remodeling module, and an empowering operation module. The scheme can establish a dual-cycle task management system, taking the strategic goals of enterprises as the starting point, and combining the status of digital operation management of various enterprises to make targeted resource investments and improvements, thereby achieving optimal resource allocation; the scheme employs process mining algorithms to comprehensively sort and optimize business processes, breaks down corporate strategic goals into different business areas to achieve the visualization of sub-goal business processes, thereby enhancing the operational efficiency of enterprises and reducing costs; the scheme utilizes automated analysis to finely manage data generated by process operations, clarifies the behavioral trajectories, waste, inefficiencies, and problem points in different business departments through data support, thereby enabling targeted training and assisting personnel in enhancing their effectiveness.

### TECHNICAL FIELD

The invention relates to the technical field of enterprise management, and in particular to a digital dual-cycle task management system for enterprise operations.

### BACKGROUND

With the widespread adoption and extensive application of information technology, the digitalization level of enterprises continues to improve. Deploying digital systems helps enhance operational efficiency, effectively improve quality, and reduce costs; these have become a focal point for businesses. However, general digital deployments in enterprises are often fragmented, failing to effectively enable digital empowerment; they also overlook the support of system processes for achieving enterprise objectives and the full utilization of data, resulting in an inability to fully realize the benefits of digital deployment. Traditional business process sorting requires a massive investment of manpower and time, consuming a significant amount of enterprise resources; furthermore, it cannot cover all aspects and is prone to overlooking critical nodes, leading to issues of poor accuracy and comprehensiveness in process sorting. Traditional analytical methods struggle to achieve a holistic perspective, with data from different business departments often existing independently, lacking integration and sharing; this neglects hidden inefficiencies and resource wastage, resulting in low reliability of analysis results.

### SUMMARY OF THE INVENTION

In view of the above situation, in order to overcome the defects of the prior art, the invention provides a digital dual-cycle task management system for enterprise operations. Aiming at the problems that general digital deployments in enterprises are often fragmented, failing to effectively enable digital empowerment, overlooking the support of system processes for achieving enterprise objectives and the full utilization of data, an inability to fully realize the benefits of digital deployment, the scheme can establish a dual-cycle task management system, taking the strategic goals of enterprises as the starting point, and combining the status of digital operation management of various enterprises to make targeted resource investments and improvements, thereby achieving optimal resource allocation. Aiming at the problems that traditional business process sorting requires a massive investment of manpower and time, consuming a significant amount of enterprise resources, cannot cover all aspects and is prone to overlooking critical nodes, leading to issues of poor accuracy and comprehensiveness in process sorting, the scheme employs process mining algorithms to comprehensively sort and optimize business processes, breaks down corporate strategic goals into different business areas to achieve the visualization of sub-goal business processes, thereby enhancing the operational efficiency of enterprises and reducing costs. Aiming at the problems that traditional analytical methods struggle to achieve a holistic perspective, with data from different business departments often existing independently, lacking integration and sharing, neglecting hidden inefficiencies and resource wastage, resulting in low reliability of analysis results, the scheme utilizes automated analysis to finely manage data generated by process operations, clarifies the behavioral trajectories, waste, inefficiencies, and problem points in different business departments through data support, automatically assign tasks to the corresponding departments, thereby enabling targeted training and assisting personnel in enhancing their effectiveness.

The invention provides a digital dual-cycle task management system for enterprise operations, comprising a process sorting module, a digital remodeling module, and an empowering operation module;

the process sorting module extracts log data from both internal and external data of the enterprise, utilizes Inductive Miner Algorithm to generate business process models, and then sends these business process models to the digital remodeling module;

the digital remodeling module constructs a CATAC cycle model (C refers to data Collection, A refers to automatic Analysis, T refers to Task triggering, A refers to Action instruction, C refers to effect Confirmation) based on the business process models and sends the CATAC cycle model to the empowering operation module;

the empowering operation module constructs a matching digital operation management mechanism and team, continuously monitors the operational data generated by the CATAC cycle model, optimizes the process, and feeds the optimization results back to the CATAC cycle model.

Further, the construction method of the business process models includes the following steps:

step Q1: determining enterprise strategic objectives, defining an objective function;

step Q2: decomposing the objective function into each business department, determining sub-objective functions for each business department, using the following formula:

$$F = {w}_{1} {f}_{1} + {w}_{2} {f}_{2} + … + {w}_{n} {f}_{n} ;$$

in the formula, F is the objective function, n is the number of business departments, ƒ₁, ƒ₂, ƒₙ are the sub-objective functions of different business departments, and w₁, w₂, wₙ are the weights of the sub-objective functions of different business departments;

step Q3: process mining involves extracting log data, using Inductive Miner Algorithm to analyze the log data, extracting events from the log data, and mining the activities contained within the events to generate business process models that show the sequence, parallel and looping structures of activities;

step Q4: analyzing the execution time, waiting time, and resource utilization of each activity;

step Q5: verifying whether the actual process meets the preset objective function; identifying deviating activities;

Further, in step Q3, the process mining includes the following steps:

step Q31: determining the business process scopes for each department based on sub-objective functions, extracting events from log data, including event ID, activity name, timestamp, resources, and other contextual information.

step Q32: converting events into sequences where each sequence represents an event, each sequence contains multiple activities, determining the order of activities in each sequence;

step Q33: frequent itemset mining, using Apriori algorithm to identify frequently occurring sets of activities, adjusting the weights of each business department, the steps are as follows:

step Q331: initializing frequent itemsets, calculating the frequency of each individual activity, filtering out infrequent activities;

step Q332: generating candidate itemsets, generating combinations of two activities, calculating the frequency of each combination, filtering out infrequent combinations;

step Q333: iteratively generating larger itemsets, for each frequent itemset of k activities, generating candidate itemsets of k+1 activities, continuing filtering out infrequent combinations until no larger item sets can be generated;

step Q34: generalizing frequent activity sets into patterns to capture generalized business processes;

step Q35: generating the business process models based on mined frequent activity sets and patterns;

step Q36: utilizing graphs to visualize sequence, parallel, and looping structures of activities.

Further, the construction method of the CATAC cycle model includes the following steps:

step 1: data collection: gathering activity data from the business process models, including equipment operation data, production data, and environmental data;

step 2: automatic analysis: calculating the average execution time, standard deviation, and degree of variation of each activity, identifying abnormal activities and structures in the business process models;

step 3: task triggering: when abnormal activities and structures are detected, tasks are automatically triggered and assigned to the corresponding business departments;

step 4: action instruction: after the business departments receive the tasks, the relevant equipment, systems, and personnel take corresponding actions.

step 5: effect confirmation: automatically verifying whether the actions taken effectively resolved the problem.

Further, in step 2, the automatic analysis includes the following steps:

step 21: calculating the average execution time, standard deviation, and coefficient of variation of each activity, a higher coefficient of variation indicates greater instability for the activity, the formulas used are as follows:

$$\overline{t} = \frac{1}{N} {\sum }_{i = 1}^{N} {t}_{i} ;$$

$$σ = \sqrt{\frac{1}{N} {\sum }_{i = 1}^{N} {( {t}_{i} - \overline{t} )}^{2} ;}$$

$$θ = \frac{σ}{\overline{t}} \times 100 \% ;$$

in the formulas, t̅ is the average execution time, i is the activity serial number, tᵢ is the execution time of the i-th activity, N is the total number of activities, σ is the standard deviation, θ is the coefficient of variation;

step 22: abnormal activity detection involves utilizing 3σ principle to identify abnormal activities, if the execution time of an activity exceeds the range of three times the standard deviation from the average execution time, that activity is labeled as an abnormal activity, the formula used is as follows:

$${t}_{i}^{′} > \overline{t} + 3 σ or {t}_{i}^{′} < \overline{t} - 3 σ ;$$

in the formula,

$${t}_{i}^{′}$$

is abnormal activity;

step 23: abnormal structure identification involves detecting the repetition frequency of activities to identify abnormal loops in loop structures; when the repetition frequency of an activity exceeds the normal range, it is marked as an abnormal loop; detecting synchronization among parallel activities to identify the abnormal parallelism of parallel structures, when the time difference between the parallel activities exceeds the normal range, it is marked as an abnormal parallel structure, the formulas used are as follows:

$${C}_{i} = {\sum }_{s = 1}^{P} {n}_{is} ;$$

$${D}_{ij} = \vert {t}_{j} - {t}_{i}^{′} \vert ;$$

in the formulas, Cᵢ is the number of repeated occurrences of each activity, s is the path sequence number, nᵢₛ is the number of occurrences of the i-th activity in the s-th path, P is total number of paths, tⱼ and tⱼ′ are the execution time of the parallel activities, Dᵢⱼ is time difference of the parallel activities.

By adopting the above scheme: the invention achieves the following advantageous effects:

(1) aiming at the problems that general digital deployments in enterprises are often fragmented, failing to effectively enable digital empowerment, overlooking the support of system processes for achieving enterprise objectives and the full utilization of data, an inability to fully realize the benefits of digital deployment, the scheme can establish a dual-cycle task management system, taking the strategic goals of enterprises as the starting point, and combining the status of digital operation management of various enterprises to make targeted resource investments and improvements, thereby achieving optimal resource allocation;

(2) aiming at the problems that traditional business process sorting requires a massive investment of manpower and time, consuming a significant amount of enterprise resources, cannot cover all aspects and is prone to overlooking critical nodes, leading to issues of poor accuracy and comprehensiveness in process sorting, the scheme employs process mining algorithms to comprehensively sort and optimize business processes, breaks down corporate strategic goals into different business areas to achieve the visualization of sub-goal business processes, thereby enhancing the operational efficiency of enterprises and reducing costs;

(3) aiming at the problems that traditional analytical methods struggle to achieve a holistic perspective, with data from different business departments often existing independently, lacking integration and sharing, neglecting hidden inefficiencies and resource wastage, resulting in low reliability of analysis results, the scheme utilizes automated analysis to finely manage data generated by process operations, clarifies the behavioral trajectories, waste, inefficiencies, and problem points in different business departments through data support, automatically assign tasks to the corresponding departments, thereby enabling targeted training and assisting personnel in enhancing their effectiveness.

### BRIEF DESCRIPTION OF THE DRAWINGS

FIG. 1 is a schematic diagram of a digital dual-cycle task management system for enterprise operations provided by the invention;

FIG. 2 is an application schematic diagram of the CATAC cycle model in embodiment 4.

The accompanying drawings are used to provide a further understanding of the invention and constitute a part of the specification; together with the embodiments of the invention, they are used to explain the invention and do not constitute a limitation of the invention.

### DESCRIPTION OF EMBODIMENTS

The technical schemes in the embodiments of the invention will be clearly and completely described in combination with the accompanying drawings in the embodiments of the invention. Obviously, the described embodiments are only some of the embodiments of the invention, but not all of the embodiments. Based on the embodiments in this invention, all other embodiments obtained by those of ordinary skill in the art without making creative efforts shall fall within the protection scope of this invention.

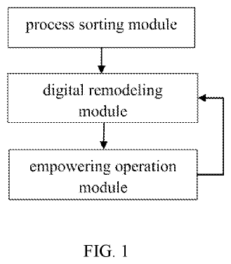

Embodiment 1: referring to FIG. 1, the invention provides the digital dual-cycle task management system for enterprise operations, comprising a process sorting module, a digital remodeling module, and an empowering operation module;

the process sorting module extracts log data from both internal and external data of the enterprise, utilizes Inductive Miner Algorithm to generate business process models, and then sends these business process models to the digital remodeling module;

the digital remodeling module constructs a CATAC cycle model based on the business process models and sends the CATAC cycle model to the empowering operation module;

the empowering operation module constructs a matching digital operation management mechanism and team, continuously monitors the operational data generated by the CATAC cycle model, optimizes the process, and feeds the optimization results back to the CATAC cycle model.

By executing the above operations, the invention aims to solve the problems that general digital deployments in enterprises are often fragmented, failing to effectively enable digital empowerment, overlooking the support of system processes for achieving enterprise objectives and the full utilization of data, an inability to fully realize the benefits of digital deployment, the scheme can establish a dual-cycle task management system, taking the strategic goals of enterprises as the starting point, and combining the status of digital operation management of various enterprises to make targeted resource investments and improvements, thereby achieving optimal resource allocation.

Embodiment 2: referring to FIG. 1, this embodiment is based on the above embodiment, the construction method of the business process models includes the following steps:

step Q1: determining enterprise strategic objectives, defining an objective function;

step Q2: decomposing the objective function into each business department, determining sub-objective functions for each business department, using the following formula:

$$F = {w}_{1} {f}_{1} + {w}_{2} {f}_{2} + … + {w}_{n} {f}_{n} ;$$

in the formula, F is the objective function, n is the number of business departments, ƒ₁, ƒ₂, ƒₙ are the sub-objective functions of different business departments, and w₁, w₂, Wₙ are the weights of the sub-objective functions of different business departments;

step Q3: process mining involves extracting log data, using Inductive Miner Algorithm to analyze the log data, extracting events from the log data, and mining the activities contained within the events to generate business process models that show the sequence, parallel and looping structures of activities;

step Q4: analyzing the execution time, waiting time, and resource utilization of each activity;

step Q5: verifying whether the actual process meets the preset objective function; identifying deviating activities.

By executing the above operations, the invention aims to solve the problems that traditional business process sorting requires a massive investment of manpower and time, consuming a significant amount of enterprise resources, cannot cover all aspects and is prone to overlooking critical nodes, leading to issues of poor accuracy and comprehensiveness in process sorting, the scheme employs process mining algorithms to comprehensively sort and optimize business processes, breaks down corporate strategic goals into different business areas to achieve the visualization of sub-goal business processes, thereby enhancing the operational efficiency of enterprises and reducing costs.

Embodiment 3: referring to FIG. 1, this embodiment is based on the above embodiment, in step Q3, the process mining includes the following steps:

step Q31: determining the business process scopes for each department based on sub-objective functions, extracting events from log data, including event ID, activity name, timestamp, resources, and other contextual information.

step Q32: converting events into sequences where each sequence represents an event, each sequence contains multiple activities, determining the order of activities in each sequence;

step Q33: frequent itemset mining, using Apriori algorithm to identify frequently occurring sets of activities, adjusting the weights of each business department, the steps are as follows:

step Q331: initializing frequent itemsets, calculating the frequency of each individual activity, filtering out infrequent activities;

step Q332: generating candidate itemsets, generating combinations of two activities, calculating the frequency of each combination, filtering out infrequent combinations;

step Q333: iteratively generating larger itemsets, for each frequent itemset of k activities, generating candidate itemsets of k+1 activities, continuing filtering out infrequent combinations until no larger item sets can be generated;

step Q34: generalizing frequent activity sets into patterns to capture generalized business processes;

step Q35: generating the business process models based on mined frequent activity sets and patterns;

step Q36: utilizing graphs to visualize sequence, parallel, and looping structures of activities.

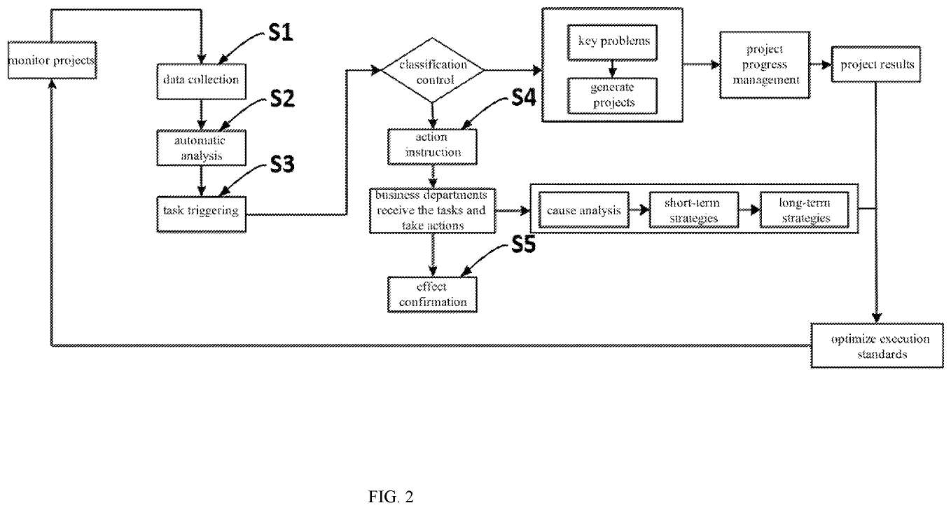

Embodiment 4: referring to FIG. 1 and FIG. 2, this embodiment is based on the above embodiment, the construction method of the CATAC cycle model includes the following steps:

step 1: data collection: gathering activity data from the business process models, including equipment operation data, production data, and environmental data;

step 2: automatic analysis: calculating the average execution time, standard deviation, and degree of variation of each activity, identifying abnormal activities and structures in the business process models;

step 3: task triggering: when abnormal activities and structures are detected, tasks are automatically triggered and assigned to the corresponding business departments, projects are generated for key problems, and attention is paid to the progress of the projects and the outcomes after the problems are resolved.

step 4: action instruction: after the business departments receive the tasks, the relevant equipment, systems, and personnel take corresponding actions, after the tasks are completed, the causes of abnormal activities and structures are analyzed, short-term and long-term strategies in response to tasks are generated, the execution standards are optimized combined with the project results, the project is continuously monitored, and the monitored data is fed back into the CATAC cycle model;

step 5: effect confirmation: automatically verifying whether the actions taken effectively resolved the problem.

By executing the above operations, the invention aims to solve the problems that traditional analytical methods struggle to achieve a holistic perspective, with data from different business departments often existing independently, lacking integration and sharing, neglecting hidden inefficiencies and resource wastage, resulting in low reliability of analysis results, the scheme utilizes automated analysis to finely manage data generated by process operations, clarifies the behavioral trajectories, waste, inefficiencies, and problem points in different business departments through data support, automatically assign tasks to the corresponding departments, thereby enabling targeted training and assisting personnel in enhancing their effectiveness.

Embodiment 5: referring to FIG. 1, this embodiment is based on the above embodiment, in step 2, the automatic analysis includes the following steps:

step 21: calculating the average execution time, standard deviation, and coefficient of variation of each activity, a higher coefficient of variation indicates greater instability for the activity, the formulas used are as follows:

$$\overline{t} = \frac{1}{N} {\sum }_{i = 1}^{N} {t}_{i} ;$$

$$σ = \sqrt{\frac{1}{N} {\sum }_{i = 1}^{N} {( {t}_{i} - \overline{t} )}^{2} ;}$$

$$θ = \frac{σ}{\overline{t}} \times 100 \% ;$$

in the formulas, t̅ is the average execution time, i is the activity serial number, tᵢ is the execution time of the i-th activity, N is the total number of activities, σ is the standard deviation, θ is the coefficient of variation;

step 22: abnormal activity detection involves utilizing 3σ principle to identify abnormal activities, if the execution time of an activity exceeds the range of three times the standard deviation from the average execution time, that activity is labeled as an abnormal activity, the formula used is as follows:

$${t}_{i}^{′} > \overline{t} + 3 σ or {t}_{i}^{′} < \overline{t} - 3 σ ;$$

in the formula,

$${t}_{i}^{′}$$

is abnormal activity;

step 23: abnormal structure identification involves detecting the repetition frequency of activities to identify abnormal loops in loop structures; when the repetition frequency of an activity exceeds the normal range, it is marked as an abnormal loop; detecting synchronization among parallel activities to identify the abnormal parallelism of parallel structures, when the time difference between the parallel activities exceeds the normal range, it is marked as an abnormal parallel structure, the formulas used are as follows:

$${C}_{i} = {\sum }_{s = 1}^{P} {n}_{is} ;$$

$${D}_{ij} = \vert {t}_{j} - {t}_{i}^{′} \vert ;$$

in the formulas, Cᵢ is the number of repeated occurrences of each activity, s is the path zsequence number, nᵢₛ is the number of occurrences of the i-th activity in the s-th path, P is total number of paths, tⱼ and tⱼ' are the execution time of the parallel activities, Dᵢⱼ is time difference of the parallel activities.

It should be noted that in this article, relational terms such as first and second are only used to distinguish one entity or operation from another entity or operation, and do not necessarily require or imply that any such actual relationship or sequence between these entities or operations. In addition, the terms “comprises”, “includes” or any other variation thereof are intended to cover a non-exclusive inclusion such that a process, method, article or apparatus including a list of elements includes not only those elements, but also includes other elements not expressly listed, or also includes the elements inherent to such process, method, article or apparatus.

Although the embodiments of the invention have been shown and described above, it should be understood that those skilled in the art can make changes, modifications, substitutions and alterations to the above embodiments without departing from the principles and spirit of the invention. The scope of the invention is defined by the claims and their equivalents.

The invention and its embodiments are described above, this description is not restrictive, and what is shown in the accompanying drawing is only one of the embodiments of the invention, and the actual structure is not limited to this. All in all, if those skilled in the art receives its enlightenment, without deviating from the object of the invention, and without creatively designing structures and embodiments similar to the technical scheme of the invention shall fall within the protection scope of the invention.

1. A digital dual-cycle task management system for enterprise operations, implemented on one or more processors and stored in a non-transitory computer-readable medium, comprising a process sorting module, a digital remodeling module, and an empowering operation module;
wherein:
the process sorting module is configured to extracts log data from both internal and external data of the enterprise, utilizes Inductive Miner Algorithm to generate business process models, and send the business process models to the digital remodeling module;
the digital remodeling module is configured to construct a CATAC cycle model based on the business process models and sends the CATAC cycle model to the empowering operation module;
the empowering operation module is configured to constructs a matching digital operation management mechanism and team, continuously monitor operational data generated by the CATAC cycle model, optimize process, and feed optimization results back to the CATAC cycle model.

2. The method of operating the system of claim 1, executed by one or more processors, comprising:
(1) constructing the business process models, the construction comprising:
step Q1: determining enterprise strategic objectives, defining an objective function;
step Q2: decomposing the objective function into each business department, determining sub-objective functions for each business department, using the following formula:
$$F = {w}_{1} {f}_{1} + {w}_{2} {f}_{2} + … + {w}_{n} {f}_{n} ;$$
in the formula, F is the objective function, n is the number of business departments, ƒ₁, ƒ₂, ƒₙ are the sub-objective functions of different business departments, and w₁, w₂, Wₙ are the weights of the sub-objective functions of different business departments;
step Q3: process mining involves extracting log data, using Inductive Miner Algorithm to analyze the log data, extracting events from the log data, and mining the activities contained within the events to generate business process models that show the sequence, parallel and looping structures of activities;
step Q4: analyzing the execution time, waiting time, and resource utilization of each activity;
step Q5 : verifying whether the actual process meets the preset objective function;
identifying deviating activities;
(2) constructing the CATAC cycle model, the construction comprising:
step 1: data collection: gathering activity data from the business process models, including equipment operation data, production data, and environmental data;
step 2: automatic analysis: calculating the average execution time, standard deviation, and degree of variation of each activity, identifying abnormal activities and structures in the business process models;
step 3: task triggering: when abnormal activities and structures are detected, tasks are automatically triggered and assigned to the corresponding business departments;
step 4: action instruction: after the business departments receive the tasks, the relevant equipment, systems, and personnel take corresponding actions.
step 5: effect confirmation: automatically verifying whether the actions taken effectively resolved the problem.

3. The method of claim 2, wherein in step Q3, the process mining includes the following steps:
step Q31: determining the business process scopes for each department based on sub-objective functions, extracting events from log data, including event ID, activity name, timestamp, resources, and other contextual information.
step Q32: converting events into sequences where each sequence represents an event, each sequence contains multiple activities, determining the order of activities in each sequence;
step Q33: frequent itemset mining, using Apriori algorithm to identify frequently occurring sets of activities, adjusting the weights of each business department, the steps are as follows:
step Q331: initializing frequent itemsets, calculating the frequency of each individual activity, filtering out infrequent activities;
step Q332: generating candidate itemsets, generating combinations of two activities, calculating the frequency of each combination, filtering out infrequent combinations;
step Q333: iteratively generating larger itemsets, for each frequent itemset of k activities, generating candidate itemsets of k+1 activities, continuing filtering out infrequent combinations until no larger item sets can be generated;
step Q34: generalizing frequent activity sets into patterns to capture generalized business processes;
step Q35: generating the business process models based on mined frequent activity sets and patterns;
step Q36: utilizing graphs to visualize sequence, parallel, and looping structures of activities.

4. The method of claim 3, wherein in step 2, the automatic analysis includes the following steps:
step 21: calculating the average execution time, standard deviation, and coefficient of variation of each activity, a higher coefficient of variation indicates greater instability for the activity, the formulas used are as follows:
$$\overline{t} = \frac{1}{N} {\sum }_{i = 1}^{N} {t}_{i} ;$$
$$σ = \sqrt{\frac{1}{N} {\sum }_{i = 1}^{N} {( {t}_{i} - \overline{t} )}^{2} ;}$$
$$θ = \frac{σ}{\overline{t}} \times 100 \% ;$$
in the formulas, t̅ is the average execution time, i is the activity serial number, tᵢ is the execution time of the i-th activity, N is the total number of activities, σ is the standard deviation, θ is the coefficient of variation;
step 22: abnormal activity detection involves utilizing 3σ principle to identify abnormal activities, if the execution time of an activity exceeds the range of three times the standard deviation from the average execution time, that activity is labeled as an abnormal activity, the formula used is as follows:
$${t}_{i}^{′} > \overline{t} + 3 σ or {t}_{i}^{′} < \overline{t} - 3 σ ;$$
in the formula,
$${t}_{i}^{′}$$
is abnormal activity;
step 23: abnormal structure identification involves detecting the repetition frequency of activities to identify abnormal loops in loop structures; when the repetition frequency of an activity exceeds the normal range, it is marked as an abnormal loop; detecting synchronization among parallel activities to identify the abnormal parallelism of parallel structures, when the time difference between the parallel activities exceeds the normal range, it is marked as an abnormal parallel structure, the formulas used are as follows:
$${C}_{i} = {\sum }_{s = 1}^{P} {n}_{is} ;$$
$${D}_{ij} = \vert {t}_{j} - {t}_{i}^{′} \vert ;$$
in the formulas, Cᵢ is the number of repeated occurrences of each activity, s is the path sequence number, nᵢₛ is the number of occurrences of the i-th activity in the s-th path, P is total number of paths, tⱼ and tⱼ′ are the execution time of the parallel activities, Dᵢⱼ is time difference of the parallel activities.
